(19) United States
(12) Patent Application Publication
(10) Pub. No.: US 2020/0201507 A1
(43) Pub. Date: Jun. 25, 2020

(54) TOUCH PANEL AND TOUCH DISPLAY DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventor: Minlun LIU, Wuhan, Hubei (CN)

(21) Appl. No.: 16/484,549

(22) PCT Filed: May 5, 2019
(86) PCT No.: PCT/CN2019/085555

§ 371 Date: Aug. 8, 2019

(30) Foreign Application Priority Data
Dec. 12, 2018 (CN) 201811519953.3

(51) Int. Cl. G06F 3/041; G06F 3/044

(52) U.S. Cl. CPC G06F 3/04164; G06F 3/0448; G06F 3/0446; G06F 3/0445

(57) ABSTRACT

This invention discloses a touch panel and a touch display device, the touch panel of the present invention can effectively solve the visibility problem caused by the etch gap of the conventional touch panel using ITO, and by disposing the auxiliary electrodes on the second electrode layer above the first electrode layer to match the first electrode layer, thereby effectively avoiding problems such as short circuit of the touch electrodes caused by etch residue.

### FIELD OF INVENTION

This invention relates to the field of touch technologies, and, in particular, to a touch panel and touch display device.

### BACKGROUND OF INVENTION

Flexible touch displays are display technologies with competitive advantages in the future. One of the advantages of the flexible touch display is that they can be bent, such that larger display areas can be obtained and occupied spaces are small, so that they are convenient for carrying and use. A flexible substrate is usually used in a conventional flexible touch display, and components such as thin film transistors or organic light emitting diodes are formed sequentially on the flexible substrate, and finally a polarizer, a touch screen and a cover glass are disposed on it.

### TECHNICAL PROBLEMS

However, with the increase of pixels per inch (PPI) of the flexible touch display, and the influence of the light transmittance of the area covered by indium tin oxide (ITO) and that of the area not covered by ITO are inconsistent, in the same display situation, visibility problems such as etching lines occur easily.

### SUMMARY OF INVENTION

An object of the present invention is to provide a touch panel, which can effectively solve the visibility problem caused by the etch gap of the conventional touch panel using ITO, and by disposing the auxiliary electrodes on the second electrode layer above the first electrode layer to match the first electrode layer, thereby effectively avoiding problems such as short circuit of the touch electrodes caused by etch residue.

According to an aspect of the invention, the present invention provides a touch panel, including a substrate; a first electrode layer disposed on the substrate, the first electrode layer including a plurality of first electrode chains and a plurality of second electrode chains; wherein the plurality of first electrode chains are spaced apart from each other, and each of the plurality of first electrode chains includes a plurality of spaced first transparent electrodes; wherein the plurality of second electrode chains are spaced apart from each other, each of the second electrode chains includes a plurality of spaced second transparent electrodes, the second electrode chains and the first electrode chains are spatially crossed and insulated from each other, a connection portion is formed at each intersection of each of the second electrode chains and each of the first electrode chains, each of the connection portions includes a first connection portion for electrically connecting adjacent two of the first transparent electrodes on the same one of the first electrode chains; and a second electrode layer disposed on the first electrode layer, the second electrode layer including: a plurality of auxiliary electrodes, each of the plurality of auxiliary electrodes disposed at a position corresponding to an etch gap region formed by one of the first transparent electrodes and adjacent one of the second transparent electrodes.

In another embodiment, the auxiliary electrodes are electrodeless.

In another embodiment, the first connection portions are disposed on the second electrode layer, a first insulating layer is disposed between the first connection portions, the first transparent electrodes and the second transparent electrodes, first through holes are defined in the first insulating layer and corresponding to the first transparent electrodes, both ends of each of the first connecting portions contact the first transparent electrodes via the first through holes penetrating the first insulating layer.

In another embodiment, a second insulating layer is disposed on the second electrode layer, and the second insulating layer covers the first connecting portions and the plurality of auxiliary electrodes.

In another embodiment, each of the connection portions further includes a second connection portion, the second connection portions and the first connection portions are spatially crossed and insulated from each other, and the second connection portions are configured for electrically connecting adjacent two of the second transparent electrodes on the same one of the second electrode chains.

In another embodiment, materials of the first transparent electrodes and the second transparent electrodes are both indium tin oxide.

In another embodiment, material of the auxiliary electrodes is indium tin oxide.

In another embodiment, materials of the first insulating layer and the second insulating layer are silicon oxide, silicon nitride or a combination of the two.

In another embodiment, the first electrode chains are sensing electrode chains, the second electrode chains are driving electrode chains; or the first electrode chains are driving electrode chains, and the second electrode chains are sensing electrode chains.

In another embodiment, the touch panel further includes a plurality of edge leads and a driving portion, the edge leads electrically connect to the first electrode layer and the driving portion, and the driving portion connects to an external touch driving chip.

According to another aspect of the invention, the present invention further provides a touch display device, including a touch panel as mentioned above.

### BENEFICIAL EFFECT

An advantage of the present invention is that the touch panel of the present invention can effectively solve the visibility problem caused by the etch gap of the conventional touch panel using ITO, and by disposing the auxiliary electrodes on the second electrode layer above the first electrode layer to match the first electrode layer, thereby effectively avoiding problems such as short circuit of the touch electrodes caused by etch residue.

### DESCRIPTION OF DRAWINGS

In order to more clearly illustrate the technical solutions in the embodiments of the present invention, the drawings which are used in the description of the embodiments will be briefly described below. It is obvious that the drawings in the following description are only some embodiments of the present invention. Other drawings can also be obtained from those skilled in the art without paying any creative effort.

FIG. 1 is a schematic exploded view of a touch panel according to an embodiment of the invention.

FIG. 2A and FIG. 2B are schematic views of a first electrode layer and a second electrode layer in the embodiment of the present invention.

FIG. 3A and FIG. 3B are schematic views of a conventional touch panel, and FIG. 3B is a partially enlarged schematic view of a region A shown in FIG. 3A.

FIG. 4A and FIG. 4B are schematic views of a touch panel in the embodiment of the present invention, and FIG. 4B is a partially enlarged schematic view of a region B shown in FIG. 4A.

FIG. 5 is a cross-sectional view of a touch panel in the embodiment of the present invention.

FIG. 6 is a schematic view of a touch display device according to an embodiment of the invention.

### DETAILED DESCRIPTION OF PREFERRED EMBODIMENTS

The technical solutions in the embodiments of the present invention are clearly and completely described in the following with reference to the accompanying drawings in the embodiments of the present invention. It is apparent that the described embodiments are only a part of the embodiments of the invention, and not all of the embodiments. All other embodiments obtained by those of ordinary skill in the art based on the embodiments of the present invention are within the scope of the present invention.

The terms “first,” “second,” “third,” if any, in the description, the claims, and the drawings may be used for distinguishing between similar elements and not necessarily for describing a particular sequential or chronological order. It is to be understood that the terms are interchangeable. Furthermore, the terms “comprise,” “include,” “have,” and any variations thereof, are intended to cover non-exclusive inclusions.

In the patent specification, the drawings discussed below and the various embodiments used to describe the principles of the present invention are intended to be illustrative only, and are not to be construed as limiting the scope of the invention. Those skilled in the art will appreciate that the principles of the present invention can be implemented in any suitably arranged system. Exemplary embodiments will be described in detail, and examples of these embodiments are illustrated in the accompanying drawings. Further, an end according to an exemplary embodiment will be described in detail with reference to the accompanying drawings. The same reference numbers in the drawings denote the same elements.

The terms used in the description of the present invention are only used to describe specific embodiments, and are not intended to show the concepts of the present invention. Unless explicitly described to the difference, a singular form includes a plural form in the present specification. In the specification of the present invention, it is to be understood that the terms such as “including,” “having,” and “comprising” are intended to indicate the existence of the features, numbers, steps, actions, or combinations in the invention, and are not intended to preclude the possibility that one or more other features, numbers, steps, actions, or combinations thereof may exist or may be added. The same reference number represents the same element in all drawings. The embodiment of the present invention provides a touch panel and a touch display device, and they will be described separately below.

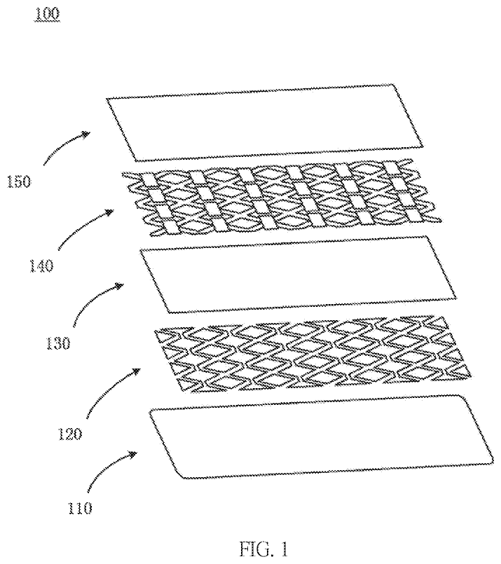

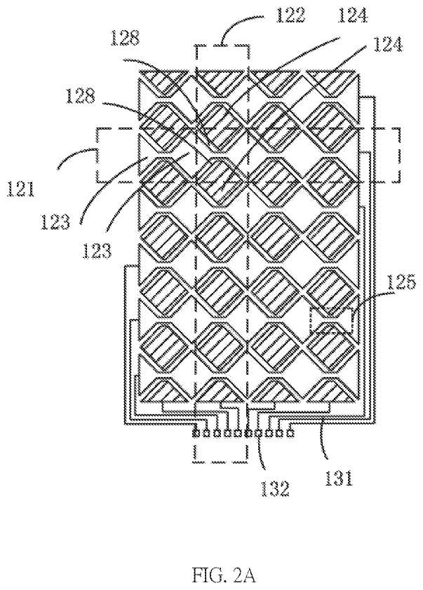

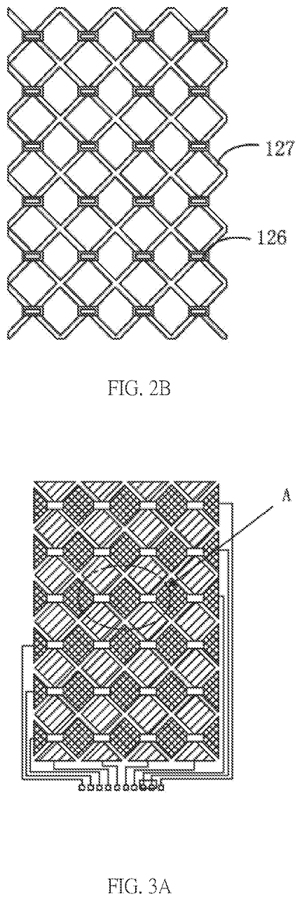

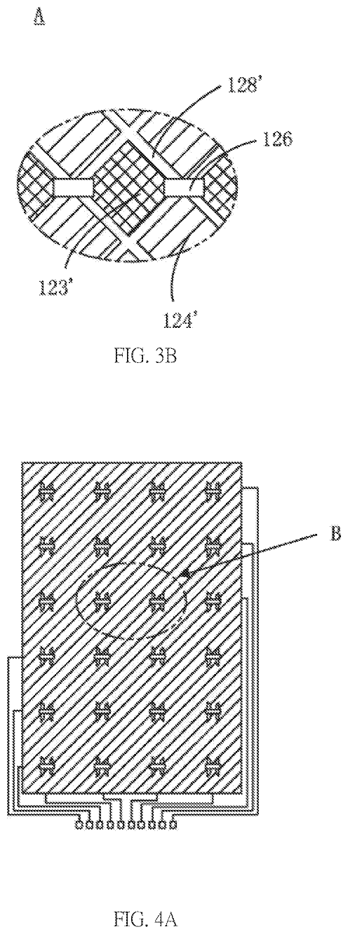

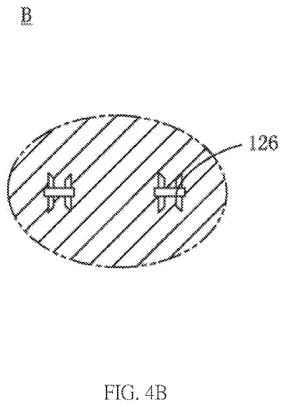

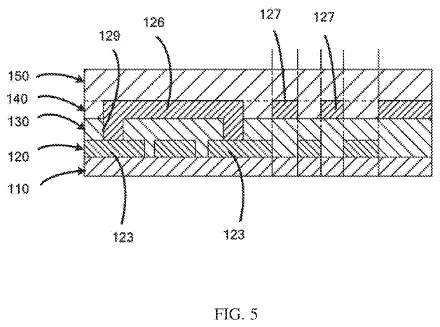

Referring to FIG. 1 to FIG. 5, FIG. 1 is a schematic exploded view of a touch panel according to an embodiment of the invention. FIG. 2A and FIG. 2B are schematic views of a first electrode layer and a second electrode layer in the embodiment of the present invention. FIG. 3A and FIG. 3B are schematic views of a conventional touch panel, and FIG. 3B is a partially enlarged schematic view of a region A shown in FIG. 3A. FIG. 4A and FIG. 4B are schematic views of a touch panel in the embodiment of the present invention, and FIG. 4B is a partially enlarged schematic view of a region B shown in FIG. 4A. FIG. 5 is a cross-sectional view of a touch panel in the embodiment of the present invention.

The present invention provides a touch panel 100, including a substrate 110; a first electrode layer 120 disposed on the substrate 110, the first electrode layer 120 including a plurality of first electrode chains 121 and a plurality of second electrode chains 122; wherein the plurality of first electrode chains 121 are disposed on the substrate 110 and spaced apart from each other, and each of the plurality of first electrode chains 121 includes a plurality of spaced first transparent electrodes 123; wherein the plurality of second electrode chains 122 are disposed on the substrate 110 and spaced apart from each other, each of the second electrode chains 122 includes a plurality of spaced second transparent electrodes 124, the second electrode chains 122 and the first electrode chains 124 are spatially crossed and insulated from each other, a connection portion 125 is formed at each intersection of each of the second electrode chains 122 and each of the first electrode chains 121, each of the connection portions 125 includes a first connection portion 126, wherein the longitudinal direction of the first connecting portions 126 is consistent with the direction of the bending axis of the touch panel 100; wherein the first connection portion 126 is used for electrically connecting adjacent two of the first transparent electrodes 123 on the same one of the first electrode chains 121; and a second electrode layer 130 disposed on the first electrode layer 120, the second electrode layer 130 including: a plurality of auxiliary electrodes 127, each of the plurality of auxiliary electrodes 127 disposed at a position corresponding to an etch gap region 128 formed by one of the first transparent electrodes 123 and adjacent one of the second transparent electrodes 124.

Specifically, the substrate 110 is a transparent substrate, such as a glass substrate, a plastic substrate, or a flexible substrate.

The first electrode layer 120 is disposed on the substrate 110, the first electrode layer 120 includes the plurality of first electrode chains 121 and the plurality of second electrode chains 122.

The plurality of first electrode chains 121 are disposed on the substrate 110 and spaced apart from each other, and each of the plurality of first electrode chains 121 includes a plurality of spaced first transparent electrodes 123.

The plurality of second electrode chains 122 are disposed on the substrate 110 and spaced apart from each other, each of the second electrode chains 122 includes a plurality of spaced second transparent electrodes 124, the second electrode chains 122 and the first electrode chains 121 are spatially crossed and insulated from each other.

Optionally, the first electrode chains 121 are sensing electrode chains, the second electrode chains 122 are driving electrode chains, the first transparent electrodes 123 are sensing electrodes, and the second transparent electrodes 124 are driving electrodes. The sensing electrodes can be called touch receiving electrodes, and the driving electrodes can be called touch transmitting electrodes. In another embodiment, the first electrode chains 121 are driving electrode chains, and the second electrode chains 122 are sensing electrode chains, the first transparent electrodes 123 are driving electrodes, and the second transparent electrodes 124 are sensing electrodes.

Referring to FIG. 1 and FIG. 5, in the embodiment, the first electrode chains 121 and the second electrode chains 122 are disposed on the same layer and formed of the same material, for example, the same transparent conductive material. Specifically, they may be made of indium tin oxide (ITO), indium gallium zinc oxide (IGZO) or metal material with high transmittance. Therefore, materials of the first transparent electrodes 123 and the second transparent electrodes 124 are the same, which may be made of transparent conductive material or metal. They can be formed simultaneously by a signal patterning process, thereby simplifying the process.

In another embodiment, the first electrode chains 121 and the second electrode chains 122 are disposed on different layers, and the first connecting portions 126 and the first electrode chains 121 are disposed on the same layer, i.e. the first connecting portions 126 and the second electrode chains 122 are disposed on different layers.

In this embodiment, the first transparent electrodes 123 and the second transparent electrodes 124 are block structures made of a transparent conductive material. Here, the first transparent electrodes 123 and the second transparent electrodes 124 are both metal, and the first electrode layer 120 formed of the first electrode chains 121 and the second electrode chains 122 is a mesh structure. The first transparent electrodes 123 and the second transparent electrodes 124 may be formed into various shapes, such as a rhombic shape, a square shape, a rectangular shape, and the like, which are not limited in the present invention.

What is preferred is that the first transparent electrodes 123 and the second transparent electrodes 124 have a rhombic shape or a square shape, the adjacent first transparent electrodes 123 of each of the first electrode chains 121 are electrically connected to each other at apexes of the rhombic shape or the square shape along a first direction by the first connecting portions 126, and the adjacent second transparent electrodes of each of the second electrode chains 122 are electrically connected to each other at apexes of the rhombic shape or the square shape along a second direction. The first direction may be a X direction or a Y direction, and the second direction may be a X direction or a Y direction. If the first direction is the X direction, the second direction is the Y direction. In the embodiment, the sensing electrodes are electrodes corresponding to the first direction (which may also be referred to as a horizontal direction), and the driving electrodes are electrodes corresponding to the second direction (which may also be referred to as a vertical direction).

In this embodiment, the first connecting portions 126 are disposed on the second electrode layer 130. What is preferred is that the material of the first connecting portions 126 may be indium tin oxide. Therefore, the materials of the first connecting portions 126, the first transparent electrodes 123 and the second transparent electrodes 124 are the same. Of course, in another embodiment, the material of the first connecting portions 126 may be other transparent conductive materials. A first insulating layer 120 is disposed between the first connection portions 126, the first transparent electrodes 123 and the second transparent electrodes 124. First through holes 129 are defined in the first insulating layer 120 and corresponding to the first transparent electrodes 123, and both ends of each of the first connecting portions 126 contact the first transparent electrodes 123 via the first through holes 129 penetrating the first insulating layer 120.

Besides the first connecting portions 126, there are further a plurality of auxiliary electrodes 127 disposed in the second electrode layer 130. What is preferred is that the material of the auxiliary electrodes 127 is the same with the material of the first connecting portions 126, and they are both indium tin oxide. Each of the plurality of auxiliary electrodes 127 is disposed at a position corresponding to an etch gap region 128 formed by one of the first transparent electrodes 123 and adjacent one of the second transparent electrodes 124. In this embodiment, what is preferred is that the auxiliary electrodes 127 are electrodeless. Because the auxiliary electrodes 127 are disposed at the positions corresponding to the etch gap regions 128 between the first transparent electrodes 123 and the second transparent electrodes 124, and the auxiliary electrodes 127 (i.e. dummy electrodes) are electrodeless, they can match the capacitance of the first transparent electrodes 123 and the second transparent electrodes 124. Further, the electrodeless first connecting portions 126 are disposed in the second electrode layer 130, so that short-circuiting between the first transparent electrodes 123 and the second transparent electrodes 124 caused by the electrodeless first connection portion 126 being disposed in the first electrode layer 120 and the etch gap being too small to cause etch residue can be avoided.

In conventional touch panels, etch gap regions 128′ are formed between adjacent first transparent electrodes 123′ and the second transparent electrodes 124′, as shown in FIG. 3B, and these etch gap regions 128′ are not covered by ITO. Therefore, in the same display situation, visibility problems such as etching lines occur easily. That is, the visibility problems are caused by inconsistent light transmittance of the area covered by ITO and the area not covered by ITO. Accordingly, the present invention provides a method, by adding ITO at positions corresponding to the etch gap regions of the second electrode layer 130 and the first electrode layer 120, to compensate ITO in the etch gap regions of the second electrode layer 130 and the first electrode layer 120, so that ITO is filled on the effective area of the almost entire touch panel 100. As shown in FIG. 4A and FIG. 4B, the structures of the first electrode layer 120 and the second electrode layer 130 are the same, thereby making the light transmittance of the touch panel 100 on the entire panel is the same, thus effectively solving the visibility problems caused by inconsistent light transmittance due to the ITO etch gap.

Further, in this embodiment, a second insulating layer 140 is disposed on the second electrode layer 130, and the second insulating layer 140 covers the first connecting portions 126 and the plurality of auxiliary electrodes 127. Materials of the second insulating layer 140 and the first insulating layer 120 are silicon oxide, silicon nitride or a combination of the two.

Further, in this embodiment, each of the connection portions 125 further includes a second connection portion (not shown), the second connection portions and the first connection portions 126 are spatially crossed and insulated from each other, and the second connection portions are configured for electrically connecting adjacent two of the second transparent electrodes 124 on the same one of the second electrode chains 122. Optionally, the second connecting portions are formed by extending the second transparent electrodes 124.

Further, the touch panel 100 further includes a plurality of edge leads 131 and a driving portion 132, the edge leads 131 electrically connect to the first electrode layer 120 and the driving portion 132, and the driving portion 132 connects to an external touch driving chip (not shown).

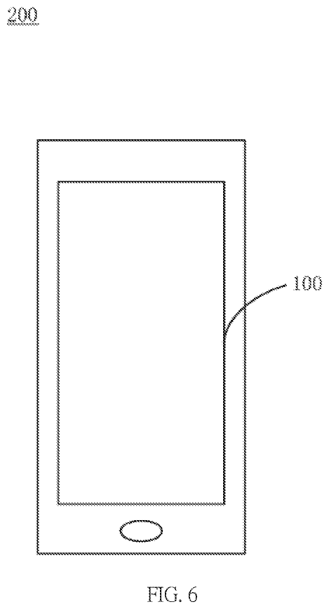

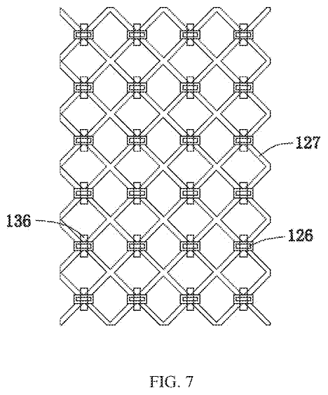

Referring to FIG. 6, FIG. 6 is a schematic view of a touch display device according to an embodiment of the invention. The present invention further provides a touch display device 200. The touch display device 200 includes the touch panel 100 provided in any of the above embodiments, and details are not described herein. The touch display device can be, but is not limited to, an e-book, a smart phone, a digital television, a tablet, a palmtop, a notebook, a mobile internet device, or a wearable device.

The touch panel 100 of the present invention can effectively solve the visibility problem caused by the etch gap of the conventional touch panel using ITO, and by disposing the auxiliary electrodes 127 on the second electrode layer 140 above the first electrode layer 120 to match the first electrode layer 120, thereby effectively avoiding problems such as short circuit of the touch electrodes caused by etch residue.

The above description is only preferred embodiments of the present invention, and it should be noted that those skilled in the art can also make several improvements and modifications without departing from the principles of the present invention. These improvements and modifications should also be considered as the scope of the present invention.

### INDUSTRIAL APPLICABILITY

The subject matter of the present application can be manufactured and used in the industry and has industrial applicability.

What is claimed is:

1. A touch panel comprising:
a substrate;
a first electrode layer disposed on the substrate, the first electrode layer comprising a plurality of first electrode chains and a plurality of second electrode chains;
wherein the plurality of first electrode chains are spaced apart from each other, and each of the plurality of first electrode chains comprises a plurality of spaced first transparent electrodes;
wherein the plurality of second electrode chains are spaced apart from each other, each of the second electrode chains comprises a plurality of spaced second transparent electrodes, the second electrode chains and the first electrode chains are spatially crossed and insulated from each other, a connection portion is formed at each intersection of each of the second electrode chains and each of the first electrode chains, each of the connection portions comprises a first connection portion for electrically connecting adjacent two of the first transparent electrodes on the same one of the first electrode chains; and
a second electrode layer disposed on the first electrode layer_{;} the second electrode layer comprising:
a plurality of auxiliary electrodes, each of the plurality of auxiliary electrodes disposed at a position corresponding to an etch gap region formed by one of the first transparent electrodes and adjacent one of the second transparent electrodes.

2. The touch panel as claimed in claim 1, wherein the auxiliary electrodes are electrodeless.

3. The touch panel as claimed in claim 1, wherein the first connection portions are disposed on the second electrode layer, a first insulating layer is disposed between the first connection portions, the first transparent electrodes and the second transparent electrodes, first through holes are defined in the first insulating layer and corresponding to the first transparent electrodes, both ends of each of the first connecting portions contact the first transparent electrodes via the first through holes penetrating the first insulating layer.

4. The touch panel as claimed in claim 3, wherein a second insulating layer is disposed on the second electrode layer, and the second insulating layer covers the first connecting portions and the plurality of auxiliary electrodes.

5. The touch panel as claimed in claim 1, wherein each of the connection portions further comprises a second connection portion, the second connection portions and the first connection portions are spatially crossed and insulated from each other, and the second connection portions are configured for electrically connecting adjacent two of the second transparent electrodes on the same one of the second electrode chains.

6. The touch panel as claimed in claim 1, wherein materials of the first transparent electrodes and the second transparent electrodes are both indium tin oxide.

7. The touch panel as claimed in claim 1, wherein material of the auxiliary electrodes is indium tin oxide.

8. The touch panel as claimed in claim 4, wherein materials of the first insulating layer and the second insulating layer are silicon oxide, silicon nitride or a combination of the two.

9. The touch panel as claimed in claim 1 wherein the first electrode chains are sensing electrode chains, the second electrode chains are driving electrode chains; or the first electrode chains are driving electrode chains, and the second electrode chains are sensing electrode chains.

10. The touch panel as claimed in claim 1, wherein the touch panel further comprises a plurality of edge leads and a driving portion, the edge leads electrically connect to the first electrode layer and the driving portion, and the driving portion connects to an external touch driving chip.

11. A touch display device, comprising a touch panel as claimed in claim
